(19) United States
(12) Patent Application Publication
(10) Pub. No.: US 2026/0274550 A1
(43) Pub. Date: Sep. 17, 2026

(54) Anti-theft and Dust-proof Aerosol Actuator

(71) Applicant: Majesty Holdings Co., Ltd., Zhongshan (CN)

(72) Inventors: Peihui Liang, Zhongshan (CN); Maoyong Zhu, Zhongshan (CN); Jun Li, Zhongshan (CN); Yonglei Zhang, Zhongshan (CN)

(21) Appl. No.: 19/245,389

(22) Filed: Jun. 22, 2025

(30) Foreign Application Priority Data
Mar. 14, 2025 (CN) 202510307732.3

(51) Int. Cl. B65D 83/224

(52) U.S. Cl. CPC B65D 83/228

(57) ABSTRACT

The present invention discloses an anti-theft and dust-proof aerosol actuator. The actuator comprises an actuator body capable of being fixedly connected to a container. The actuator body is provided with a press head, the press head is provided with a spray head, and the spray head is provided with a spout. The spray head is pivotally connected to a dust-proof cap configured to cover the spout. An outer cap is connected to the actuator body. The outer cap comprises an upper cap and an anti-theft base connected to the upper cap via a plurality of connecting ribs. After the connecting ribs are broken by screwing the upper cap, the upper cap is separated from the anti-theft base. The design prevents contamination via the dust cap and deters theft through the irreversible breakage mechanism.

### CROSS REFERENCE TO RELATED APPLICATIONS

The present application claims the benefit of Chinese Patent Application No. 2025103077323 filed on Mar. 14, 2025, the contents of which are incorporated herein by reference in their entirety.

### TECHNICAL FIELD

The present application relates to the technical field of aerosol, more particularly, to an anti-theft and dust-proof aerosol actuator.

### BACKGROUND ART

Since the birth of aerosol canisters in 1931, manufacturers have made widespread use of this technology. To date, thousands of products have been incorporated into aerosol canisters, including hair sprays, paints, pharmaceuticals, etc. The aerosol actuator is an important part of the aerosol canister. By pressing the aerosol actuator at the top of the aerosol canister, the product enclosed in the aerosol canister is ejected as a mist.

The aerosol canisters currently on the market are provided with an outer cap for protecting the aerosol actuator, the outer cap being directly fitted over the upper end of the aerosol canister. In this case, the outer cap is easily removed and replaced when sold publicly, or is used in advance when not sold. However, the seller and the consumer cannot directly judge from the appearance whether the aerosol canister has been replaced with the outer cap or previously used.

In addition, many users tend to lose the outer cap after using the aerosol canister, or choose not to return the outer cap for the next use. Thus, when the aerosol canister is stored at a later time, the aerosol actuator is not protected by the outer cap, the spout is in direct contact with the outside, and dust in the outside easily enters the interior of the actuator via the spout, thereby contaminating the contents of the aerosol canister which are then ejected via the spout.

The present application has been made based on this situation.

### SUMMARY OF THE INVENTION

It is an object of the present application to provide an anti-theft and dust-proof aerosol actuator which has significant anti-theft performance and excellent dust-proof effect so as to overcome the deficiencies of the prior art.

The technical solution adopted by the present application in order to solve the technical problem thereof is as follows.

An anti-theft and dust-proof aerosol actuator includes an actuator body which is fixedly connected to a container, wherein the actuator body is provided with a press head; a spray head is provided on the press head; a spout is provided on the spray head; a dust-proof cap pivotally connected to the spray head and configured to cover the spout; an outer cap is connected to the actuator body; the outer cap includes an upper cap and an anti-theft base connected to the upper cap via a plurality of connecting ribs; and after the connecting ribs are broken by screwing the upper cap, the upper cap is separated from the anti-theft base.

Preferably, the actuator body is fixedly connected to the anti-theft base via a snap connection; a lower end face of the actuator body is annularly provided with a rotation-stopping tooth portion; an inner wall of the anti-theft base is provided with a plurality of rotation-stopping protrusions corresponding to the rotation-stopping tooth portion; and the rotation-stopping tooth portion and the rotation-stopping protrusions cooperate to limit the rotation of the anti-theft base relative to the actuator body.

Preferably, an inner wall of the anti-theft base is annularly provided with a clamping groove; and an outer peripheral surface of the actuator body located below the rotation-stopping tooth portion is circumferentially provided with an annular rim configured to be clamped in the clamping groove.

Preferably, an annular step is provided on an outer side of the actuator body; the outer peripheral surface of the actuator body above the step is provided with an outwardly convex first fastening line; and a second fastening line matching with the first fastening line is provided along a circumferential inner wall of the upper cap.

Preferably, the dust-proof cap is pivotally connected to the spray head and is rotatable relative to the spout.

Preferably, the dust-proof cap includes connecting arms extending from both sides; the spray head is provided with guide grooves for accommodating the connecting arms which are provided with pivot ends; the guide grooves are provided with pivot holes for inserting the pivot ends; and the dust-proof cap is pivotally connected to the spray head through the pivot ends in conjunction with the pivot holes, and is rotatable along the guide grooves with respect to the spout.

Preferably, a limiting block is provided on the outer wall of the spray head; and the limiting block abuts against the dust-proof cap to restrict the rotation of the dust-proof cap in a closed state with respect to the spout.

Preferably, the connecting arm is provided with a projection on the outside.

Preferably, the upper cap, the anti-theft base and the connecting rib are integrally formed.

The invention has the following beneficial effects compared to prior art.
1. The present application provides an anti-theft base and an upper cap which are connected by a connecting rib. When it is used for the first time, it is necessary to screw the upper cap so that the connecting rib is broken for later use, and an irreversible separated state is formed, so that a seller and a consumer can directly judge whether a product has been illegally opened or replaced by observing the integrity of the connecting rib, so as to effectively prevent the goods from being used in advance when they are not sold or the outer cap from being maliciously exchanged.
2. The present application adds a pivotable dust-proof cap to provide flexible covering and secure closure of the spout by the limiting block and guide grooves design to prevent dust from entering the interior of the actuator via the spout even if the outer cap is missing or not closed back.

### BRIEF DESCRIPTION OF THE DRAWINGS

FIG. 1 is a schematic view showing an overall structure of the present application;

FIG. 2 is a structurally schematic exploded view of the present application;

FIG. 3 is a cross-sectional view of the present application.

FIG. 4 is a structurally schematic view of an actuator body of the present application in a state where a dust-proof cap is closed;

FIG. 5 is a structurally schematic view of the actuator body of the present application in a state where the dust-proof cap is opened;

FIG. 6 is a structurally schematic view of an outer cap according to the present application; and

FIG. 7 is a cross-sectional view of the present application as installed in an aerosol canister.

### DETAILED DESCRIPTION OF THE INVENTION

The technical solutions in the embodiments of the present application will be clearly and completely described below in combination with the accompanying drawings.

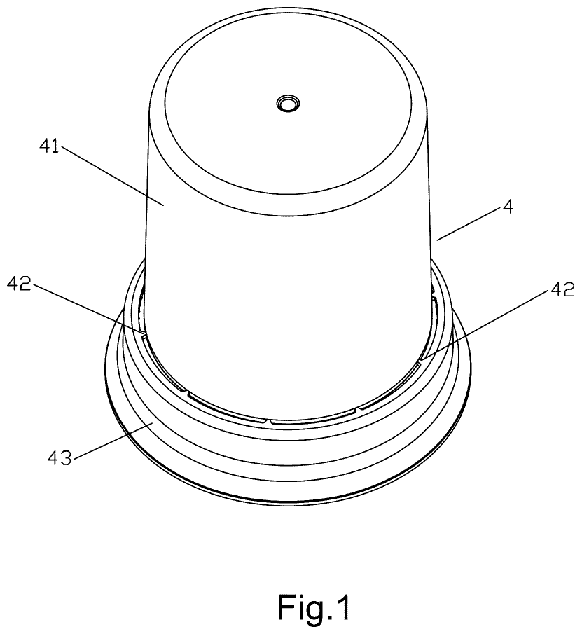

As shown in FIGS. 1 to 3, the present application provides an anti-theft and dust-proof aerosol actuator, including an actuator body 2 which is fixedly connected to a container 1, wherein the actuator body 2 is provided with a press head 21; a spray head 22 is provided on the press head 21; a spout 23 is provided on the spray head 22; a dust-proof cap 3 pivotally connected to the spray head 22 and configured to cover the spout 23; an outer cap 4 is connected to the actuator body 2; the outer cap 4 includes an upper cap 41 and an anti-theft base 43 connected to the upper cap 41 via a plurality of connecting ribs 42; and after the connecting ribs 42 are broken by screwing the upper cap 41, the upper cap 41 is separated from the anti-theft base 43.

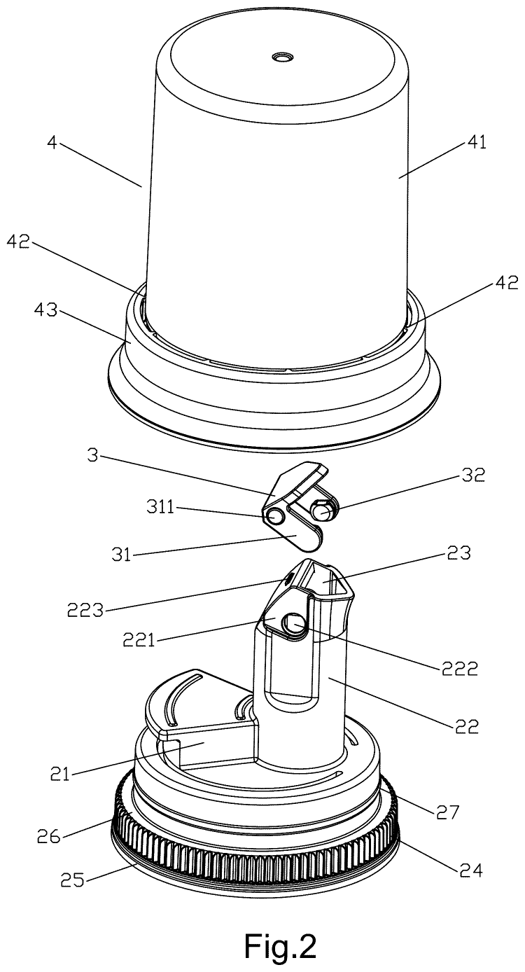

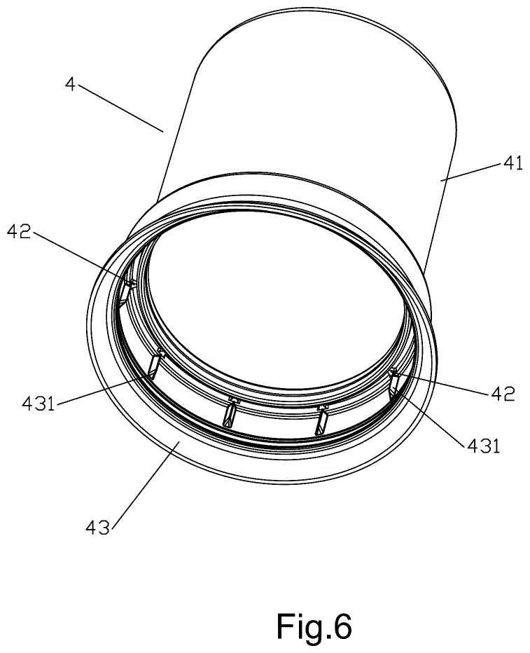

As shown in FIGS. 2, 3 and 6, the actuator body 2 is fixedly connected to the anti-theft base 43 via a snap connection; a lower end face of the actuator body 2 is annularly provided with a rotation-stopping tooth portion 24; an inner wall of the anti-theft base 43 is provided with a plurality of rotation-stopping protrusions 431 corresponding to the rotation-stopping tooth portion 24; and the rotation-stopping tooth portion 24 and the rotation-stopping protrusions 431 cooperate to limit the rotation of the anti-theft base 43 relative to the actuator body 2 so as to facilitate the screwing of the upper cap 41.

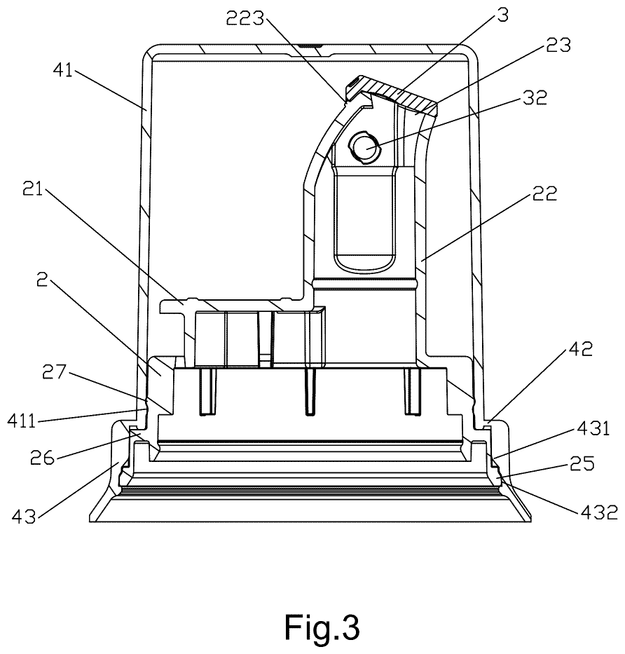

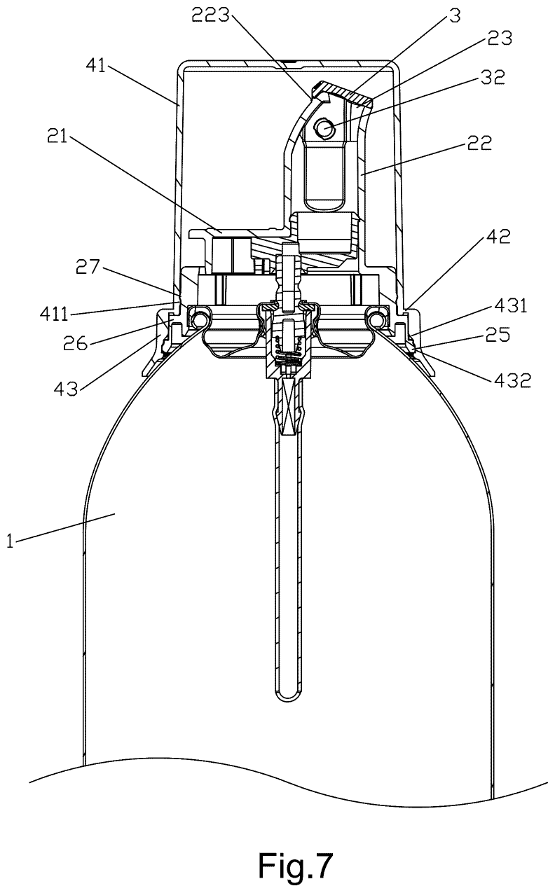

As shown in FIGS. 3 and 7, the inner wall of the anti-theft base 43 is annularly provided with a clamping groove 432. The outer peripheral surface of the actuator body 2 located below the rotation-stopping tooth portion 24 is circumferentially provided with an annular rim 25, and the annular rim 25 is clamped in the clamping groove 432 so as to achieve an interference fit between the anti-theft base 43 and the actuator body 2, ensuring the stability of the fixed connection between the both, and preventing the aerosol canister from being opened in advance by directly removing the anti-theft base 43.

When the aerosol canister is used for the first time, since the anti-theft base 43 is restrained from being separated from the actuator body 2 by the actuator body 2, it is necessary to separate the upper cap 41 from the anti-theft base 43 by screwing the upper cap 41 so that the connecting rib 42 is broken. After the upper cap 41 separated from the anti-theft base 43 is removed from the actuator body 2, the aerosol canister can be normally used by opening the dust-proof cap 3. The breakage of the connection rib 42 may form an irreversible theft-proof mark, so that the seller and the consumer can directly judge whether the product has been illegally opened or replaced by observing the integrity of the external connection rib 42 of the aerosol canister product, effectively preventing the aerosol canister product from being used in advance when it is not sold or the outer cap 4 from being maliciously exchanged.

As shown in FIGS. 3 to 7, the outer side of the actuator body 2 is provided with an annular step 26, the outer peripheral surface of the actuator body 2 located above the annular step 26 is provided with an outwardly convex first fastening line 27, and a second fastening line 411 matching the first fastening line 27 is provided along the circumferential inner wall of the upper cap 41. After the aerosol canister is used for the first time, the upper cap 41 separated from the anti-theft base 43 can be detachably fixed to the actuator body 2 by means of the engagement of the first fastening line 27 and the second fastening line 411, so as to seal and protect the actuator body 2 and prevent external dust from contacting the spout 23.

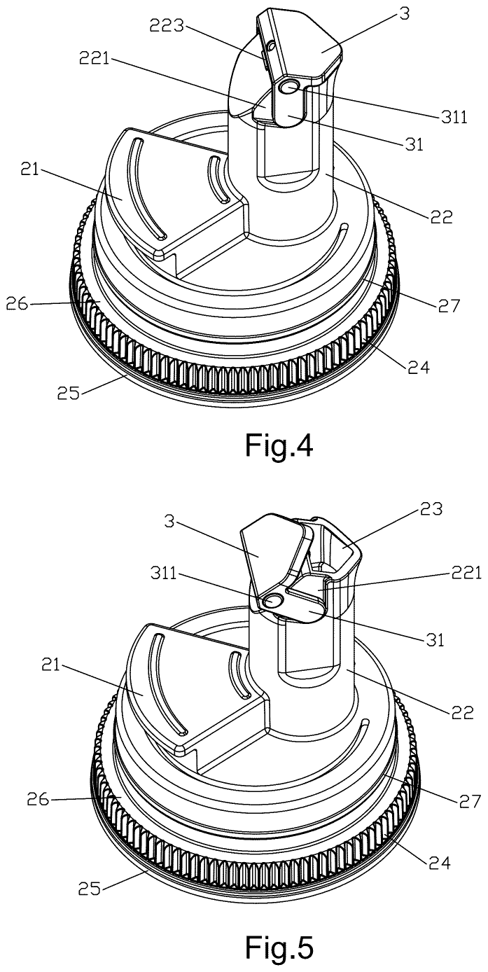

As shown in FIGS. 4 and 5, the dust-proof cap 3 is pivotally connected to the spray head 22 and can rotate relative to the spout 23. After using the aerosol canister, the user can rotate the dust-proof cap 3 to a closed state, so that the inner wall of the dust-proof cap 3 completely shields the spout 23, and effectively prevents external dust from entering the spout 23, and the dust-proof cap 3 can independently seal the spout 23 even if the upper cap 41 is lost.

As shown in FIGS. 2 to 5, in the present embodiment, the dust-proof cap 3 includes connecting arms 31 extending from both sides. The spray head 22 is provided with guide grooves 221 for accommodating the connecting arms 31. The connecting arms 31 are each provided with a pivot end 32. The guide grooves 221 are provided with a pivot hole 222 for inserting the pivot end 32. The dust-proof cap 3 is pivotally connected to the spray head 22 through the pivot ends 32 in conjunction with the pivot holes 222, and can rotate along the guide grooves 221 relative to the spout 23. The guide grooves 221 limit the moving range of the connecting arms 31, prevent the dust-proof cap 3 from shifting or shaking during rotation, and ensure a smooth opening and closing action. In practical applications, the pivot connection mode of the dust-proof cap 3 and the spray head 22 can be replaced by a hinge structure, and the dust-proof cap 3 is opened and closed by means of a hinge shaft.

As shown in FIGS. 2 to 4, a limiting block 223 is provided on the outer wall of the spray head 22, and the limiting block 223 abuts against the dust-proof cap 3 so as to limit the rotation of the dust-proof cap 3 in a closed state relative to the spout 23. Thus, the dust-proof cap 3 is stable in the closed state, preventing the dust-proof cap 3 from being accidentally opened due to vibration or mis-touch, and ensuring that the spout 23 is always in a sealed state.

As shown in FIG. 2, FIG. 4 and FIG. 5, a projection 311 is provided on the outside of the connecting arm 31 to increase the friction between the user's finger and the connecting arm 31 when the user rotates the dust-proof cap 3, so as to facilitate the user to open and close the dust-proof cap 3.

In the present application, the upper cap 41, the anti-theft base 43, and the connection rib 42 are integrally formed, so that the assembly process is reduced, and the uniformity and consistency of the connection rib 42 can be ensured while improving the production efficiency.

The above-mentioned are only preferred implementations of the present application. Any technical solution that achieves the purpose of the present application by basically the same means falls within the protection scope of the present application.

1. An anti-theft and dust-proof aerosol actuator, comprising an actuator body (2) which is fixedly connected to a container (1), wherein the actuator body (2) is provided with a press head (21); a spray head (22) is provided on the press head (21); a spout (23) is provided on the spray head (22); a dust-proof cap (3 ) pivotally connected to the spray head (22) and configured to cover the spout (23); an outer cap (4) is connected to the actuator body (2); the outer cap (4) comprises an upper cap (41) and an anti-theft base (43) connected to the upper cap (41) via a plurality of connecting ribs (42); and after the connecting ribs (42) are broken by screwing the upper cap (41), the upper cap (41) is separated from the anti-theft base (43).

2. The anti-theft and dust-proof aerosol actuator according to claim 1, wherein the actuator body (2) is fixedly connected to the anti-theft base (43) via a snap connection; a lower end face of the actuator body (2) is annularly provided with a rotation-stopping tooth portion (24); an inner wall of the anti-theft base (43) is provided with a plurality of rotation-stopping protrusions (431) corresponding to the rotation-stopping tooth portion (24); and the rotation-stopping tooth portion (24) and the rotation-stopping protrusions (431) cooperate to limit the rotation of the anti-theft base (43) relative to the actuator body (2).

3. The anti-theft and dust-proof aerosol actuator according to claim 2, wherein an inner wall of the anti-theft base (43) is annularly provided with a clamping groove (432); and an outer peripheral surface of the actuator body (2) located below the rotation-stopping tooth portion (24) is circumferentially provided with an annular rim (25) configured to be clamped in the clamping groove (432).

4. The anti-theft and dust-proof aerosol actuator according to claim 1, wherein an annular step (26) is provided on an outer side of the actuator body (2); the outer peripheral surface of the actuator body (2) above the annular step (26) is provided with an outwardly convex first fastening line (27); and a second fastening line (411) matching with the first fastening line (27) is provided along a circumferential inner wall of the upper cap (41).

5. The anti-theft and dust-proof aerosol actuator according to claim 1, wherein the dust-proof cap (3) is pivotally connected to the spray head (22) and is rotatable relative to the spout (23).

6. The anti-theft and dust-proof aerosol actuator according to claim 5, wherein the dust-proof cap (3) comprises connecting arms (31) extending from both sides; the spray head (22) is provided with guide grooves (221) for accommodating the connecting arms (31) which are provided with pivot ends (32); the guide grooves (221) are provided with pivot holes (222) for inserting the pivot ends (32); and the dust-proof cap (3) is pivotally connected to the spray head (22) through the pivot ends (32) in conjunction with the pivot holes (222), and is rotatable along the guide grooves

(221) with respect to the spout (23).

7. The anti-theft and dust-proof aerosol actuator according to claim 6, wherein a limiting block (223) is provided on the outer wall of the spray head (22); and the limiting block (223) abuts against the dust-proof cap (3) to restrict the rotation of the dust-proof cap (3) in a closed state with respect to the spout (23).

8. The anti-theft and dust-proof aerosol actuator according to claim 6, wherein the connecting arm (31) is provided with a projection (311) on the outside.

9. The anti-theft and dust-proof aerosol actuator according to claim 1, wherein the upper cap (41), the anti-theft base (43) and the connecting rib (42) are integrally formed.
